(19) United States
(12) Patent Application Publication
(10) Pub. No.: US 2016/0325487 A1
(43) Pub. Date: Nov. 10, 2016

(54) INCREASED INTERLAYER ADHESION OF THREE-DIMENSIONAL PRINTED ARTICLES

(71) Applicant: EMPIRE TECHNOLOGY DEVELOPMENT LLC, Wilmington, DE (US)

(72) Inventor: Seth A. Miller, Englewood, CO (US)

(73) Assignee: EMPIRE TECHNOLOGY DEVELOPMENT LLC, Wilmington, DE (US)

(21) Appl. No.: 15/109,833

(22) PCT Filed: Feb. 24, 2014
(86) PCT No.: PCT/US14/18098

§ 371 Date: Jul. 6, 2016

(51) Int. Cl. B29C 59/14; B33Y 50/02; B33Y 30/00; B29C 67/00; B33Y 10/00

(52) U.S. Cl. CPC B29C 59/14; B29C 67/0062; B29C 67/0085; B33Y 10/00; B33Y 30/00; B29C 67/0088; B33Y 50/02; B29C 2059/145

(57) ABSTRACT

Technologies are generally described to increase interlayer adhesion of a 3D printed article. A printhead of a 3D printing system may include an extrusion nozzle configured to deposit one or more polymer layers onto a substrate to form the 3D printed article. A microplasma source may be coupled to the extrusion nozzle and may be configured to treat a surface of the substrate or a surface of the deposited polymer layers with plasma from the microplasma. The plasma may include at least one reactive species that may oxidize the surface of the substrate or the surface of the deposited polymer layer upon treatment in order to increase the interlayer adhesion of the 3D printed article.

### BACKGROUND

Unless otherwise indicated herein, the materials described in this section are not prior art to the claims in this application and are not admitted to be prior art by inclusion in this section.

While the first three-dimensional (3D) printed articles were generally models, the industry is quickly advancing by creating 3D printed articles that may be functional parts in more complex systems, such as hinges, tools, and structural elements. Many of these parts may bear a mechanical load, and the stronger the parts' load-bearing capabilities, the more generalized the parts' functional applications may be. An arising mechanical challenge for more advanced 3D printed articles may be delamination due to poor surface adhesion between layers of the formed 3D printed article, especially when plastics are used in formation.

Current attempts in 3D printing systems to solve such mechanical issues could use improvements and/or alternative or additional solutions to increase surface adhesion between the layers of the formed 3D printed article.

### SUMMARY

The present disclosure generally describes methods, apparatuses, systems, devices, and/or computer program products employed to increase interlayer adhesion of a three-dimensional (3D) printed article.

According to some examples, methods are described to increase interlayer adhesion of a 3D printed article. An example method may include depositing a polymer layer from an extrusion nozzle of a 3D printer onto a substrate to form the 3D printed article, where the extrusion nozzle is coupled to a microplasma source. The example method may also include treating a surface of the substrate or a surface of the deposited polymer layer with plasma from the microplasma source.

According to other examples, printheads may be described. An example printhead may include an extrusion nozzle configured to deposit one or more polymer layers onto a substrate to form a 3D printed article. The example printhead may also include a microplasma source coupled to the extrusion nozzle, the microplasma source being configured to treat a surface of the substrate or a surface of the deposited polymer layer with plasma from the microplasma source.

According to further examples, systems for increasing interlayer adhesion of a 3D printed article are described. An example system may include a deposition module that includes an extrusion nozzle and is configured to deposit one or more polymer layers from the extrusion nozzle onto a substrate to form a 3D printed article. The example system may also include a treatment module including a microplasma source coupled to the extrusion nozzle and configured to treat a surface of the substrate or a surface of the one or more deposited polymer layers with plasma from the microplasma source. The example system may further include a controller configured to coordinate operations of the deposition module and the treatment module during a fabrication of the 3D printed article.

According to yet further examples, a computer-readable storage medium with instructions stored thereon to increase interlayer adhesion of a 3D printed article may be described. The instructions may cause a method, similar to the methods provided above, to be performed when executed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIGS. 1A and 1B illustrate example configurations of a printhead employed in a three-dimensional (3D) printing system to increase interlayer adhesion of a 3D printed article;

FIG. 2 illustrates an example comparison of surface adhesion of a substrate with plasma treatment and a substrate without plasma treatment;

FIGS. 3A and 3B illustrate examples of microplasma sources that may be coupled to an extrusion nozzle;

FIG. 4 illustrates another example of a microplasma source that may be coupled to an extrusion nozzle;

FIG. 5 illustrates an example system to increase interlayer adhesion of a 3D printed article through employment of an extrusion nozzle coupled to a microplasma source;

FIG. 6 illustrates a general purpose computing device, which may be used to facilitate an increase of interlayer adhesion of a 3D printed article through employment of an extrusion nozzle coupled to a microplasma source;

FIG. 7 is a flow diagram illustrating an example method to increase interlayer adhesion of a 3D printed article through employment of an extrusion nozzle coupled to a microplasma source that may be performed by a computing device such as the computing device in FIG. 6; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar articles, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, among other things, to methods, apparatuses, systems, devices, and/or computer program products related to an increase of interlayer adhesion of a 3D printed article.

Briefly stated, technologies are generally described to increase interlayer adhesion of a 3D printed article. A printhead of a 3D printing system may include an extrusion nozzle configured to deposit one or more polymer layers onto a substrate to form the 3D printed article. A microplasma source may be coupled to the extrusion nozzle and may be configured to treat a surface of the substrate or a surface of a deposited polymer layer with plasma from the microplasma source. The plasma may include at least one reactive species that may oxidize the surface of the substrate or the surface of the deposited polymer layer upon treatment in order to increase the interlayer adhesion of the 3D printed article.

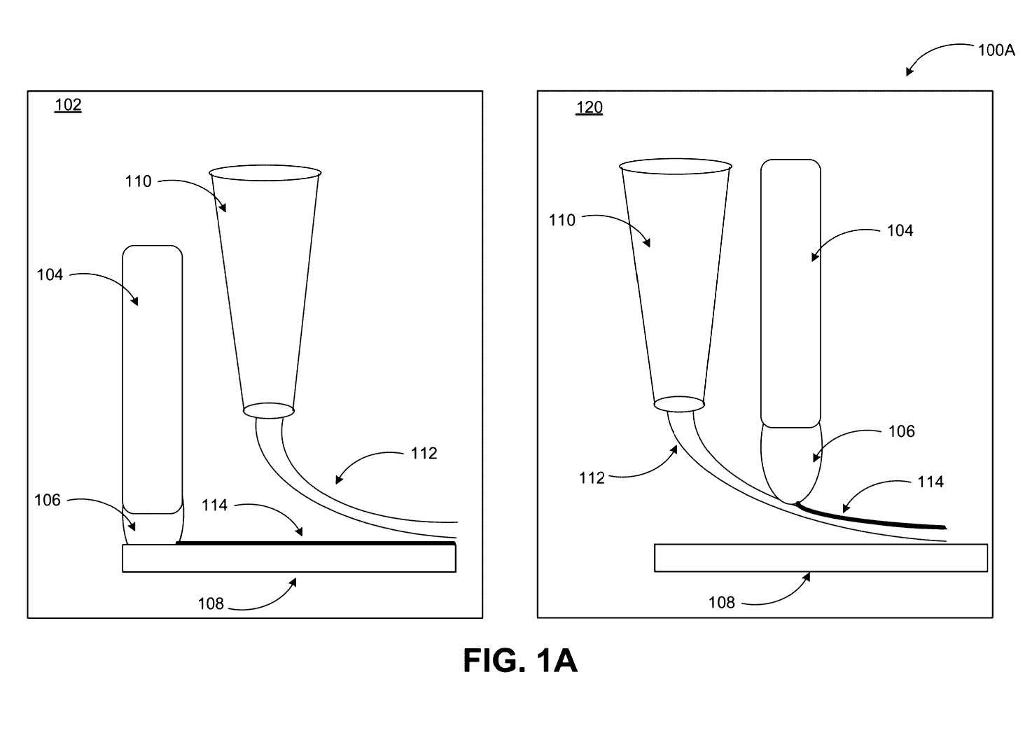

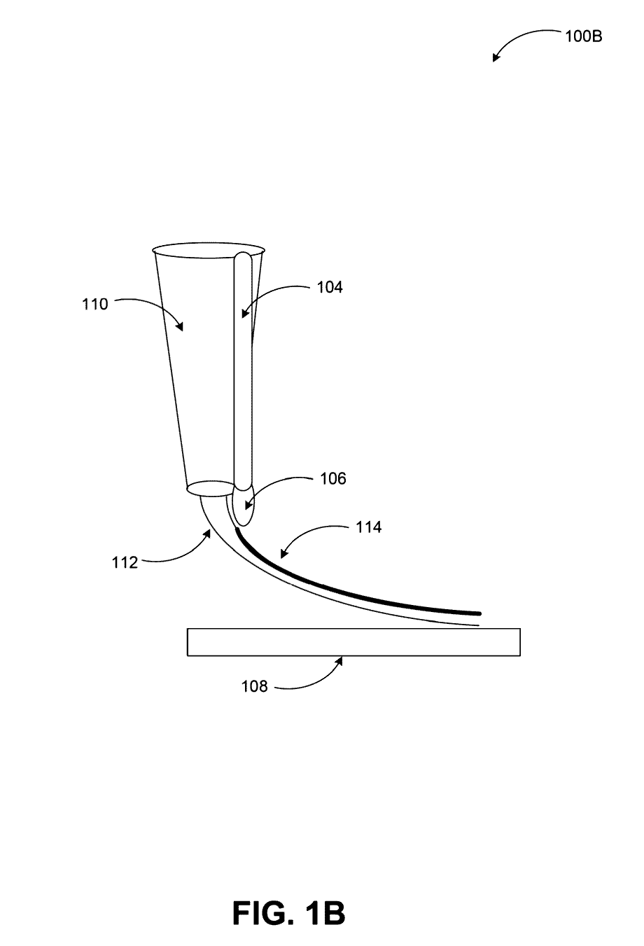

FIGS. 1A and 1B illustrate example configurations of a printhead employed in a 3D printing system to increase interlayer adhesion of a 3D printed article, arranged in accordance with at least some embodiments described herein.

As shown in a diagram 100A, a printhead of a 3D printing system may include an extrusion nozzle 110 and a microplasma source 104. The extrusion nozzle 110 may be configured to deposit one or more polymer layers onto a surface of a substrate 108 as illustrated by a path of polymer deposition 112. In some examples, the extrusion nozzle 110 may be further configured to rotate as the polymer layer is deposited to track changes in the polymer deposition. The microplasma source 104 may be configured to treat 114 the surface of the substrate or treat the surface of the one or more deposited polymer layers dependent on a position of the microplasma source 104 relative to a position of the extrusion nozzle 110. The surfaces may be treated with a plasma drop 106 from the microplasma source 104 in response to a voltage application to at least one of two electrodes positioned in the microplasma source 104.

In one embodiment, the microplasma source 104 may be positioned such that the plasma drop 106 precedes the path of polymer deposition 112 from the extrusion nozzle 110 to treat 114 a surface of a substrate 108, as illustrated in configuration 102. In another embodiment, the microplasma source 104 may be positioned such that the plasma drop 106 follows the path of polymer deposition 112 from the extrusion nozzle 110 to treat the surface of a previously deposited polymer layer, as illustrated in a configuration 120. For purposes, of this section, the configuration 102 may be referred to as a leading plasma configuration and the configuration 120 may be referred to as a trailing plasma configuration.

As shown in a diagram 100B of FIG. 1B, an alternate configuration of the printhead may include the microplasma source 104 incorporated with the extrusion nozzle 110 to cause the surface of the one or more polymer layers to be treated 114 with the plasma drop 106 as the polymer layers are deposited along the path of deposition 112 from the extrusion nozzle 110 onto the surface of the substrate 108.

The plasma from the microplasma source 104 may include at least one reactive species, such as a hydroxyl radical or nitrogen oxide radical, that is formed by one or more gases activated within the microplasma source 104. The gases may include gases naturally present in air, such as hydrogen, nitrogen, and/or oxygen, for example. If the microplasma source 104 is in an open configuration that allows gas to pass through the microplasma source 104, the gases may be passed through and/or supplied to the microplasma source 104 and activated. If the microplasma source 104 is in a closed configuration such that gas is prevented from passing through the microplasma source 104, the microplasma source 104 may ionize gases in an ambient atmosphere of the microplasma source 104 to activate the gases in order to form the radical species within the plasma.

A voltage may then be applied to at least one of two electrodes positioned within the microplasma source 104. The applied voltage may cause the plasma drop 106 from the microplasma source 104 to treat 114 the surface of the substrate 108 or surface of the deposited polymer layer with the plasma from the microplasma source 104. The radical species formed within the plasma may oxidize the surface of the substrate or the surface of the deposited polymer layer. Surface oxidation may increase an interlayer adhesion between the substrate or deposited polymer layer and a next layer to be deposited from the extrusion nozzle 110.

In some embodiments, two or more microplasma sources may be coupled to the extrusion nozzle. The microplasma sources may be positioned relative to the extrusion nozzle such that at least one plasma drop precedes a polymer deposition from an extrusion nozzle in a leading plasma configuration and at least one plasma drop follows a path of polymer deposition from the extrusion nozzle in a trailing plasma configuration. The microplasma sources may be positioned at a distance, for example, from about 0.5 mm to about 1 mm above the surface of the substrate or a surface of a previously deposited polymer layer dependent on the microplasma sources position relative to the extrusion nozzle. For example, a microplasma source positioned in the trailing plasma configuration may be positioned at a higher height above the surface of the substrate than a microplasma source positioned in the leading plasma configuration. In other embodiments, the microplasma source may be separate from the extrusion nozzle within the printhead.

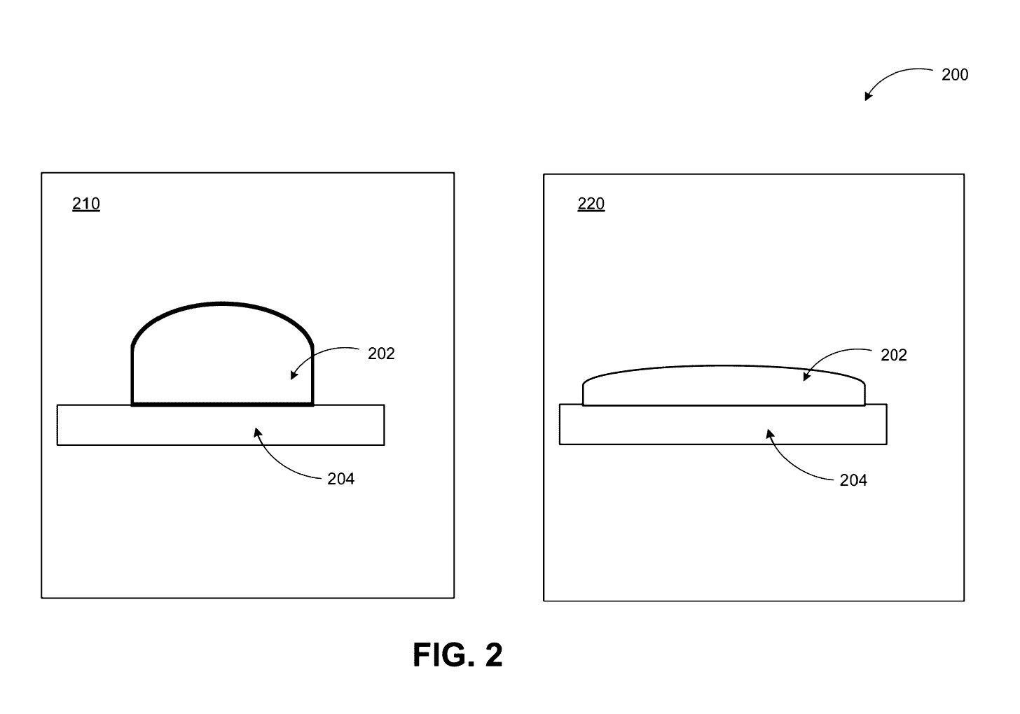

FIG. 2 illustrates an example comparison of surface adhesion of a substrate with plasma treatment and a substrate without plasma treatment, arranged in accordance with at least some embodiments described herein.

As shown in a diagram 200, a water droplet 202 on a surface of a substrate 204 may illustrate effects of plasma treatment on surface adhesion. In configuration 210, the surface of the substrate 204 has not been treated with plasma. In configuration 220, the surface of the substrate 204 has been treated with plasma from a microplasma source as discussed previously in FIG. 1. As illustrated in configuration 220, the water droplet 204 has greater surface area contact with the substrate 204 than in configuration 210, which may be indicative of increased surface adhesion as a result of plasma treatment.

The plasma from the microplasma source used to treat the substrate 204 in configuration 220 may include at least one reactive species, such as a hydroxyl radical or nitrogen oxide radical, that is formed by one or more gases activated within the microplasma source. The one or more gases may include gases naturally present in the air, such as hydrogen, nitrogen, and/or oxygen, for example. The radical species formed within the plasma may oxidize the surface of the substrate 204 to increase the surface adhesion. For example, the radical species may etch a chemistry of the surface to change a chemically inert surface into a polar, oxidized surface, where the polar, oxidized surface may have improved bonding properties that allow the surface adhesion to increase. The plasma from the microplasma source may further improve bonding and increase surface adhesion by cleaning the surface of the substrate 204 of absorbed hydrocarbons and oils and physically etching the surface of the substrate 204 to create micro-scale roughness, for example.

The plasma within the microplasma source may be a macro-scale dielectric barrier discharge (DBD), a microhollow plasma, or radio frequency (RF) plasma. A size of the plasma may generally be any size, for example, less than 1 mm² in size, for example. Due to the small size of the plasma drop, the energy needed to create the plasma within the microplasma source may be optimally focused on the surface of the substrate or surface of the deposited polymer layer to be treated. As a result, the plasma may efficiently oxidize the surface(s) to be treated at a high rate as the plasma is dropped from the microplasma source, while leaving other regions of a 3D printed article undisturbed.

In some embodiments, the plasma within the microplasma source may be maintained at a pressure, such as at an atmospheric temperature. To maintain the plasma at atmospheric pressure, two high voltage electrodes (a cathode and an anode) positioned at a small distance from one another within the microplasma source may be implemented. Application of voltage to these electrodes may also cause the plasma drop from the microplasma source to treat the surface of the substrate or the surface of the deposited polymer layer, as discussed previously.

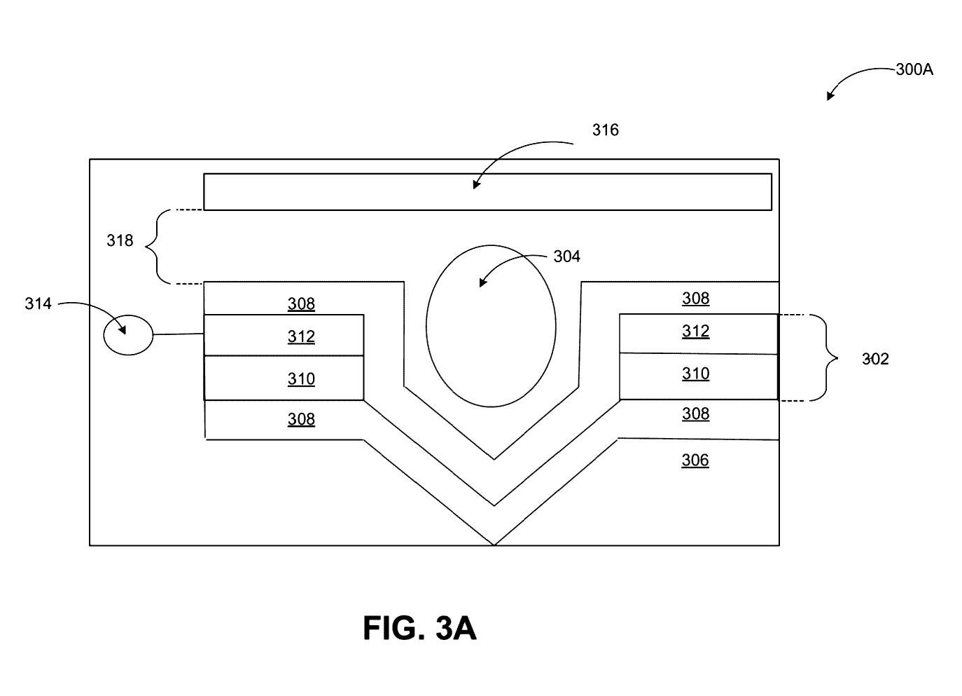

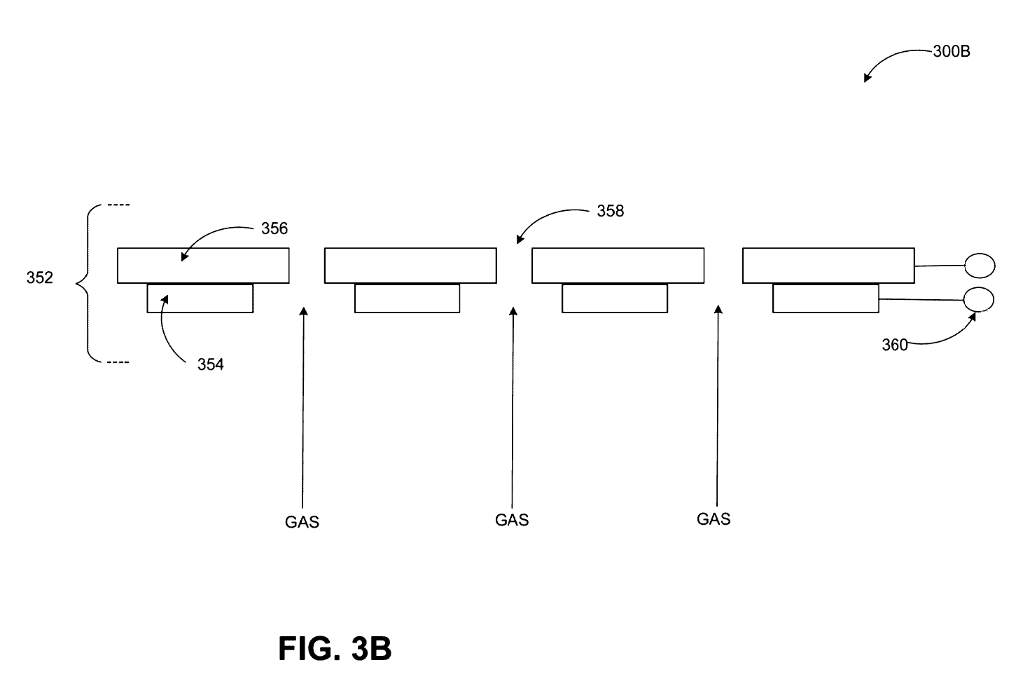

FIGS. 3A and 3B illustrate examples of microplasma sources that may be coupled to an extrusion nozzle, arranged in accordance with at least some embodiments described herein.

As shown in a diagram 300A of FIG. 3A, the microplasma source may be a dielectric barrier discharge (DBD) device 302 configured to produce DBD plasma 304. The DBD device 302 may be fabricated into a silicon chip 306, where the silicon chip 306 may serve as a cathode. In the DBD device 302, a dielectric layer 310 may separate the silicon chip 306 from a sputtered metal layer 312, which may serve as an anode. The DBD device 302 may be encapsulated in a silicon nitride layer 308. Due to the configuration of the DBD device 302, the DBD device 302 may be in a closed configuration, which may prevent one or more gases from passing through the DBD device 302. The DBD device 302 may instead ionize gases present in an ambient atmosphere of the DBD device 302 to activate the gases to form a radical species within the DBD plasma. A voltage 314 may then be applied to the anode, the sputtered metal layer 312 of the DBD device 302. The applied voltage 314 may cause a plasma drop of DBD plasma 304 from the DBD device 302 to a surface of a substrate 316 to treat the surface. The reactive species within the DBD plasma 304 may cause oxidation of the treated surface, which may increase interlayer adhesion between the substrate 316 and a next layer of polymer to be deposited by an extrusion nozzle.

The DBD device 302 may be positioned at a height, such as from about 0.5 mm to about 1 mm above the surface of the substrate to prevent direct contact of the DBD device 302 to the surface of the substrate. The height may be dependent on how the DBD device 302 is positioned relative to the extrusion nozzle. For example, the DBD device 302 may be positioned at a lower height above the surface of the substrate 316 if the DBD device 302 is positioned relative to the extrusion nozzle such that the DBD plasma 304 drop precedes deposition of a polymer layer from the extrusion nozzle. The DBD device 302 may be positioned at a higher height above the surface of the substrate 316 if the DBD device 302 is positioned relative to the extrusion nozzle such that the DBD plasma 304 drop follows deposition of a polymer layer from the extrusion nozzle.

As shown in a diagram 300B of FIG. 3B, the microplasma source may be an alternate configuration of a DBD device 352 configured to produce DBD plasma. The alternate configuration of the DBD device 352 may include two or more pieces of metal, such as aluminum (for example, 354 and 356) with one or more perforations 358 drilled through the aluminum. The perforations 358 may allow the DBD device 352 to be in an open configuration, which allows gas to be passed continuously through the DBD device. The aluminum may be anodized to form aluminum oxide on one or more surfaces of the aluminum pieces after the perforations are drilled to create the DBD plasma. The open configuration of the DBD device 352 may allow gas passing through the perforations 358 to activate in the DBD device 352 to form a reactive species within the DBD plasma. Upon application of a voltage 360, a plasma drop may treat a surface of a substrate or surface of a deposited polymer layer with the DBD plasma including the reactive species. The reactive species may cause oxidation of the treated surfaces, which may increase interlayer adhesion between the substrate or deposited polymer layer and a next layer of polymer to be deposited by the extrusion nozzle.

Similar to the DBD device 302 described previously in the diagram 300A of FIG. 3A, the DBD device 352 may be positioned at a height, such as about 0.5 mm to about 1 mm above the surface of the substrate to prevent direct contact of the DBD device 352 to the surface of the substrate. The height may be dependent on how the DBD device 352 is positioned relative to the extrusion nozzle. For example, the DBD device 352 may be positioned at a lower height above the surface of the substrate if the DBD device 352 is positioned relative to the extrusion nozzle such that the plasma drop precedes deposition of a polymer layer from the extrusion nozzle. The DBD device 352 may be positioned at a higher height above the surface of the substrate if the DBD device 352 is coupled in relation to the extrusion nozzle such that the plasma drop follows deposition of a polymer layer from the extrusion nozzle.

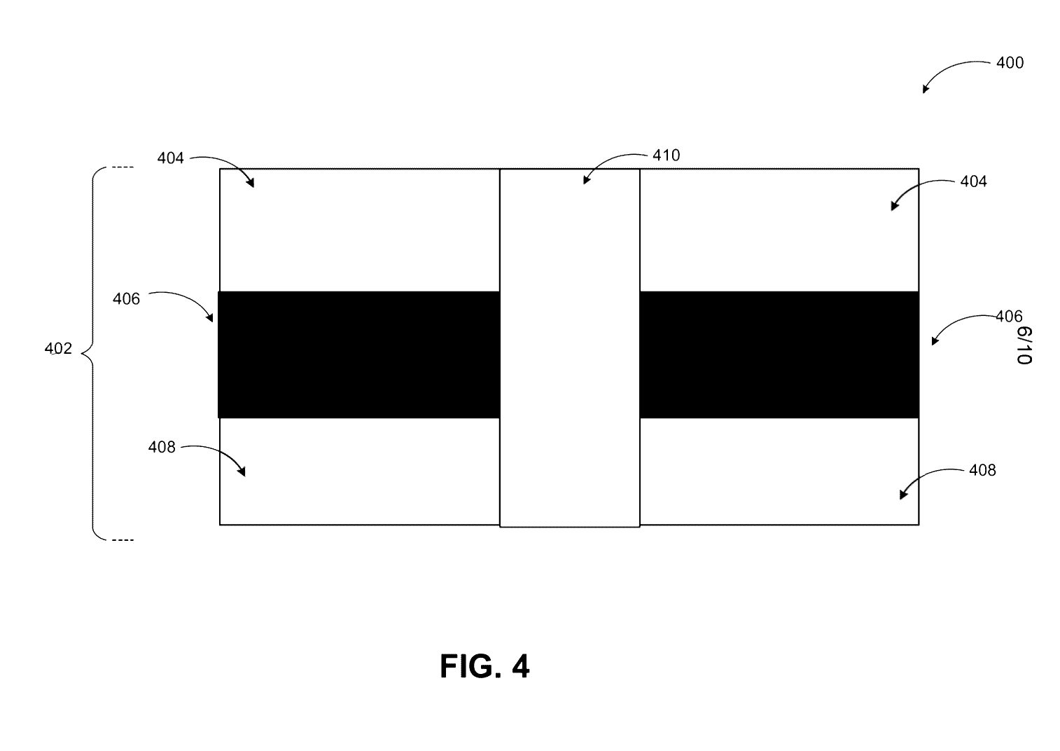

FIG. 4 illustrates another example of a microplasma source that may be coupled to an extrusion nozzle, arranged in accordance with at least some embodiments described herein.

As shown in a diagram 400, the microplasma source may be a microhollow plasma source 402 configured to produce microhollow plasma. The microhollow plasma source 402 may include an insulating dielectric layer 406 formed in between a cathode 408 and an anode 404. The microhollow plasma source 402 may also include one or more perforations 410 extending through the cathode 408, dielectric layer 406, and anode 404. The perforations may be formed with a laser following formation of the cathode 408, dielectric layer 406, and anode 404 configuration. The perforations 410 may allow the microhollow plasma source 402 to be in an open configuration, which allows one or more gases to be passed and/or supplied continuously through the microhollow plasma source 402. The gases may be activated within the microhollow plasma source 402 to form at least one reactive species within the microhollow plasma. Upon application of a voltage to the anode 404, a plasma drop may treat a surface of a substrate or surface of a deposited polymer layer with the microhollow plasma including the reactive species. The reactive species within the microhollow plasma may cause oxidation of the treated surfaces, which may increase interlayer adhesion between the substrate or deposited polymer layer and a next polymer layer to be deposited form the extrusion nozzle.

The microhollow plasma produced may have a high density, such as from about 10¹⁴ electrons per cubic centimeter (electrons/cc) to about 10¹⁵ electrons/cc, and a high temperature, such as from about 1000 Kelvin (K) to about 2000 K, for example. The temperature of the microhollow plasma may be significantly higher than DBD plasma produced from a DBD device discussed previously in FIGS. 3A and 3B, which may be a temperature from approximately about 290 K to about 500 K. Although the high temperature may be severe for simple surface oxidation, the high density of the microhollow plasma may be well suited towards transforming organic surfaces at high sweep rates, and therefore well suited for 3D printing. To make the microhollow plasma more efficient for 3D printing, the effective temperature may be lowered, for example, by passing room temperature gas through the perforations 410 at a rapid rate to lower the average gas temperature applied to the surface of the substrate or deposited polymer layer.

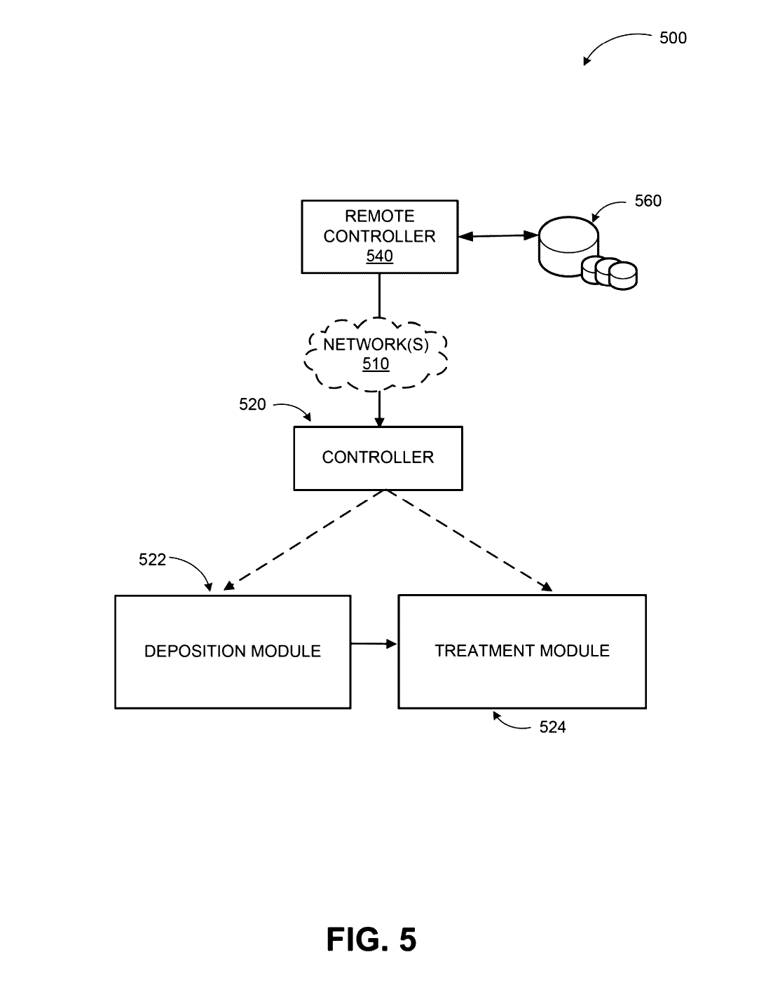

FIG. 5 illustrates an example system to increase interlayer adhesion of a 3D printed article through employment of an extrusion nozzle coupled to a microplasma source, arranged in accordance with at least some embodiments described herein.

System 500 may include at least one controller 520, at least one deposition module 522, and at least one treatment module 524. The controller 520 may be operated by human control or may be configured for automatic operation, or may be directed by a remote controller 550 through at least one network (for example, via network 510). Data associated with controlling the different processes of production may be stored at and/or received from data stores 560.

The controller 520 may include or control the deposition module 522 configured to deposit one or more polymer layers from an extrusion nozzle of a 3D printhead onto a substrate to form a 3D article. The controller 520 may also include or control the treatment module 524 configured to treat a surface of the substrate or a surface of the deposited polymer layers with plasma from a microplasma source coupled to the extrusion nozzle. The plasma may include at least one reactive species that may oxidize the treated surfaces to increase interlayer adhesion of the 3D printed article. The surfaces may be treated with a plasma drop, the plasma drop including the at least one reactive species, upon application of a voltage to at least one of two electrodes positioned within the microplasma source causing the plasma drop from the microplasma source.

As discussed previously, the microplasma source may be coupled to the extrusion nozzle. The microplasma source may be positioned relative to the extrusion nozzle such that the plasma drop from the microplasma source precedes a path of polymer deposition from the extrusion nozzle in a leading plasma configuration or follows a path of polymer deposition from the extrusion nozzle in a trailing plasma configuration. If the microplasma source is positioned in the leading plasma configuration, the surface of the substrate may be treated to increase interlayer adhesion. If the microplasma source is positioned in the trailing plasma configuration, the surface of the previously deposited polymer layers may be treated to increase interlayer adhesion.

The examples in FIGS. 1 through 5 have been described using specific apparatuses, configurations, and systems to increase interlayer adhesion of a 3D printed article through employment of an extrusion nozzle coupled to a microplasma source. Embodiments to increase interlayer adhesion of a 3D printed article are not limited to the specific apparatuses, configurations, and systems according to these examples.

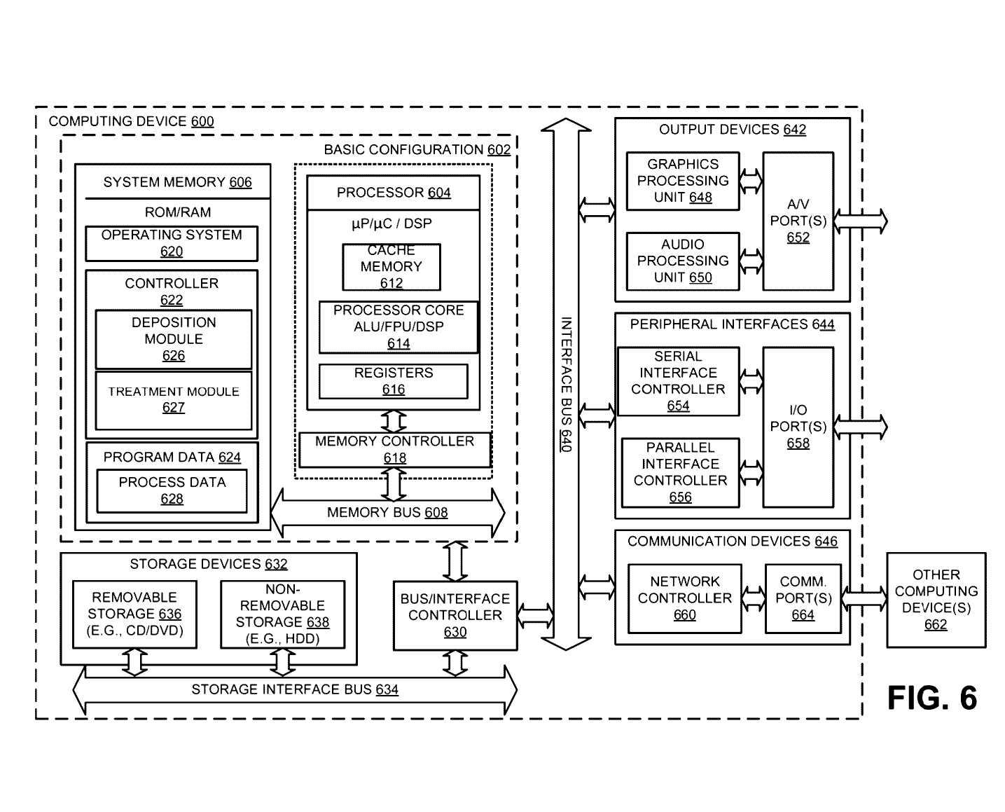

FIG. 6 illustrates a general purpose computing device, which may be used to facilitate an increase of interlayer adhesion of a 3D printed article through employment of an extrusion nozzle coupled to a microplasma source, arranged in accordance with at least some embodiments described herein.

For example, the computing device 600 may be used as a server, desktop computer, portable computer, smart phone, special purpose computer, or similar device such as a controller, a new component, a cluster of existing components in an operational system including a vehicle and a smart dwelling. In an example basic configuration 602, the computing device 600 may include one or more processors 604 and a system memory 606. A memory bus 608 may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, an application 622, and program data 624. The application 622 may include a deposition module 626 and a treatment module 627, which may be an integral part of the application or a separate application on its own. The deposition module 626 may be configured to deposit one or more polymer layers from an extrusion nozzle of a 3D printhead onto a substrate to form a 3D article. The treatment module 627 may be configured to treat a surface of the substrate or a surface of the deposited polymer layers with plasma from a microplasma source coupled to the extrusion nozzle. The program data 624 may include, among other data, process data 628 related to deposition and treatment, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers, client devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

Example embodiments may also include a printhead with at least one extrusion nozzle coupled to a microplasma source employed in a 3D printing system to increase interlayer adhesion of a 3D printed article. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

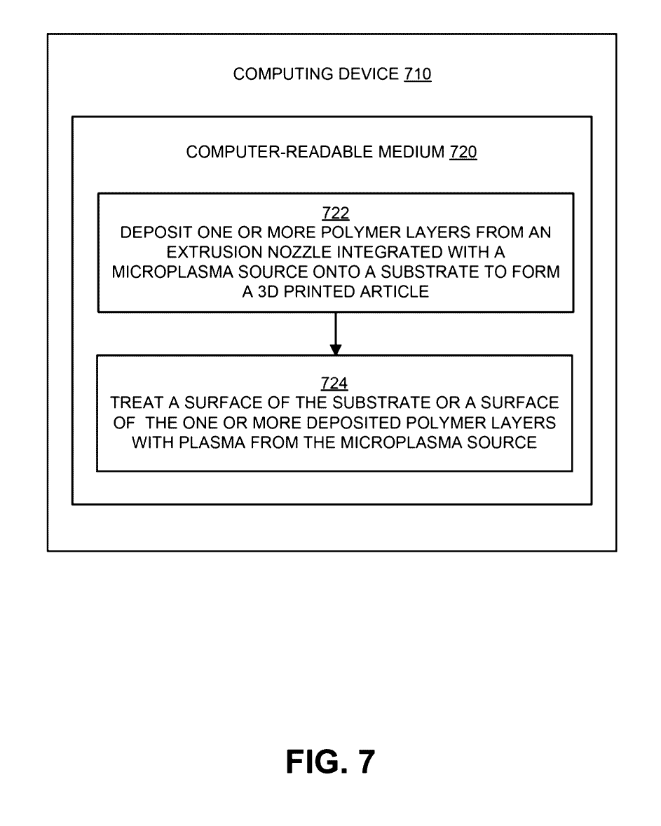

FIG. 7 is a flow diagram illustrating an example method to increase interlayer adhesion of a 3D printed article through employment of at least one extrusion nozzle coupled to a microplasma source that may be performed by a computing device such as the computing device in FIG. 6, arranged in accordance with at least some embodiments described herein.

Example methods may include one or more operations, functions or actions as illustrated by one or more of blocks 722 and/or 724. The operations described in the blocks 722 through 724 may also be stored as computer-executable instructions in a computer-readable medium such as a computer-readable medium 720 of a computing device 710.

An example process to increase interlayer adhesion of a 3D printed article may begin with block 722, “DEPOSIT ONE OR MORE POLYMER LAYERS FROM AN EXTRUSION NOZZLE INTEGRATED WITH A MICROPLASMA SOURCE ONTO A SUBSTRATE TO FORM A 3D PRINTED ARTICLE,” where a deposition module may be configured to deposit one or more polymer layers from an extrusion nozzle onto a substrate to form a 3D printed article. The extrusion nozzle may be coupled to a microplasma source, where the microplasma source may be positioned relative to the extrusion nozzle such that a plasma drop for the microplasma source may precede or follow a path of polymer deposition from the extrusion nozzle.

Block 722 may be followed by block 724, “TREAT A SURFACE OF THE SUBSTRATE OR A SURFACE OF THE ONE OR MORE DEPOSITED POLYMER LAYERS WITH PLASMA FROM THE MICROPLASMA SOURCE,” where a treatment module may be configured to treat a surface of the substrate or a surface of deposited polymer layers with plasma from the microplasma source dependent on the position of the microplasma source relative to the extrusion nozzle. For example, if the microplasma source is positioned relative to the extrusion nozzle such that the plasma drop from the microplasma source precedes the path of polymer deposition in a leading plasma configuration, the surface of the substrate may be treated. If the microplasma source is positioned relative to the extrusion nozzle such that the plasma drop from the microplasma source follows the path of polymer deposition in a trailing plasma configuration, the surface of the previously deposited polymer layers may be treated. The surface of the substrate or the surface of deposited polymer layers may be treated upon application of a voltage to at least one of two electrodes positioned within the microplasma source causing a plasma drop from the microplasma source. The plasma may include a reactive species formed within the microplasma source, where the reactive species oxidizes the surface of the substrate or the surface of deposited polymer layers, which may increase interlayer adhesion.

The blocks included in the above described process are for illustration purposes. Employment of an extrusion nozzle coupled to a microplasma source in a 3D printing system to increase interlayer adhesion of a 3D printed article may be implemented by similar processes with fewer or additional blocks. In some embodiments, the blocks may be performed in a different order. In some other embodiments, various blocks may be eliminated. In still other embodiments, various blocks may be divided into additional blocks, or combined together into fewer blocks.

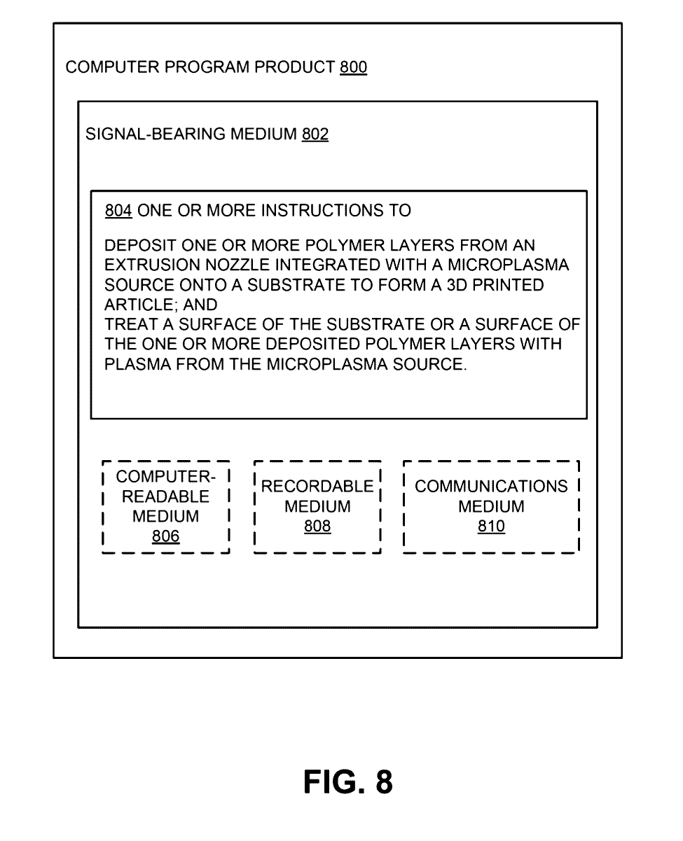

FIG. 8 illustrates a block diagram of an example computer program product, arranged in accordance with at least some embodiments described herein.

In some embodiments, as shown in FIG. 8, the computer program product 800 may include a signal bearing medium 802 that may also include one or more machine readable instructions 804 that, when executed by, for example, a processor, may provide the functionality described herein. Thus, for example, referring to the processor 604 in FIG. 6, a deposition module 626 and a treatment module 627 executed on the processor 604 may undertake one or more of the tasks shown in FIG. 8 in response to the instructions 804 conveyed to the processor 604 by the medium 802 to perform actions associated with increasing interlayer adhesion of a 3D printed article as described herein. Some of those instructions may include, for example, one or more instructions to deposit one or more polymer layers from an extrusion nozzle integrated with a microplasma source onto a substrate to form a 3D printed article, and treat a surface of the substrate or a surface of the one or more deposited polymer layers with plasma from the microplasma source, according to some embodiments described herein.

In some implementations, the signal bearing medium 802 depicted in FIG. 8 may encompass a computer-readable medium 806, such as, but not limited to, a hard disk drive, a solid state drive, a Compact Disc (CD), a Digital Versatile Disk (DVD), a digital tape, memory, etc. In some implementations, the signal bearing medium 802 may encompass a recordable medium 808, such as, but not limited to, memory, read/write (R/W) CDs, R/W DVDs, etc. In some implementations, the signal bearing medium 802 may encompass a communications medium 810, such as, but not limited to, a digital and/or an analog communication medium (for example, a fiber optic cable, a waveguide, a wired communications link, a wireless communication link, etc.). Thus, for example, the program product 800 may be conveyed to one or more modules of the processor 604 of FIG. 6 by an RF signal bearing medium, where the signal bearing medium 802 is conveyed by the wireless communications medium 810 (for example, a wireless communications medium conforming with the IEEE 802.11 standard).

According to some embodiments, methods are described to increase interlayer adhesion of a 3D printed article. An example method may include depositing a polymer layer from an extrusion nozzle of a 3D printer onto a substrate to form the 3D printed article, where the extrusion nozzle is coupled to a microplasma source. The example method may also include treating a surface of the substrate or a surface of the deposited polymer layer with plasma from the microplasma source.

In other embodiments, one or more gases may be supplied to the microplasma source, where the one or more gases may be activated to form at least one reactive species in the plasma that oxidizes the surface of the substrate or the surface of the deposited polymer layer to increase an interlayer adhesion. A voltage may be applied to cause a plasma drop from the microplasma source onto the surface of the substrate or the surface of the deposited polymer layer to treat the surface of the substrate or the surface of the deposited polymer layer with the plasma from the microplasma source. The microplasma source may be positioned in relation to the extrusion nozzle such that the plasma drop precedes or follows a path of a polymer deposition from the extrusion nozzle. The plasma drop from the microplasma source may be caused onto a surface of a previously deposited polymer layer prior to a deposition of another polymer layer.

In further embodiments, the microplasma source may be positioned at a distance, such as from about 0.5 mm to about 1 mm above the surface of the substrate or the surface of the deposited polymer layer. The extrusion nozzle may be rotated as the polymer layer is deposited to track changes in a polymer deposition. The microplasma source may be incorporated into the extrusion nozzle to allow treatment of the polymer layer with the plasma as the polymer layer is deposited from the extrusion nozzle.

According to some examples, printheads may be described. An example printhead may include an extrusion nozzle configured to deposit one or more polymer layers onto a substrate to form a 3D printed article. The example printhead may also include a microplasma source coupled to the extrusion nozzle, the microplasma source being configured to treat a surface of the substrate or a surface of the deposited polymer layer with plasma from the microplasma source.

In other examples, the example printhead may further include two or more electrodes configured to apply a voltage to cause a plasma drop from the microplasma source onto the surface of the substrate or the surface of each polymer layer in order to oxidize the surface of the substrate or the surface of each polymer layer, where the two or more electrodes may be positioned within the microplasma source. The microplasma source may be positioned in relation to the extrusion nozzle such that the plasma drop precedes or follows a path of the extrusion nozzle. A surface area of the plasma drop may be arranged to be less than about 1 mm² in size. Oxidization of the surface of the substrate or the surface of each polymer layer may increase interlayer adhesion of a 3D printed article.

In further examples, the plasma within the microplasma source may be a macro-scale dielectric barrier discharge (DBD) plasma, a microhollow plasma, or radio frequency (RF) plasma, and the plasma may be maintained at atmospheric pressure. The microplasma source comprising DBD plasma may be composed of one or more silicon chips or two or more pieces of perforated aluminum. The microplasma source may be configured to deposit plasma with at least one reactive species to treat the surface of the substrate or the surface of the deposited polymer layer. One or more gases may be configured to pass through the microplasma source in an open configuration to allow activation of the one or more gases to form the at least one reactive species. The microplasma source may be configured to ionize one or more gases present in the microplasma source in a closed configuration to allow activation of the one or more gases to form the at least one reactive species, where the at least one reactive species include a hydroxyl radical or nitrogen oxide radical.

According to some embodiments, systems for increasing interlayer adhesion of a 3D printed article are described. An example system may include a deposition module that includes an extrusion nozzle and is configured to deposit one or more polymer layers from the extrusion nozzle onto a substrate to form a 3D printed article. The example system may also include a treatment module including a microplasma source coupled to the extrusion nozzle and configured to treat a surface of the substrate or a surface of the one or more deposited polymer layers with plasma from the microplasma source. The example system may further include a controller configured to coordinate operations of the deposition module and the treatment module during a fabrication of the 3D printed article.

In other embodiments, the treatment module may be configured to treat the surface of the substrate or the surface of the one or more deposited polymer layers with plasma from the microplasma source in response to an application of a voltage by two or more electrodes causing a plasma drop from the microplasma source. The treatment module may include two or more microplasma sources coupled to the extrusion nozzle, where the two or more microplasma sources may be positioned in relation to the extrusion nozzle such that at least two plasma drops precede and follow a path of polymer deposition from the extrusion nozzle.

In further embodiments, the two or more microplasma sources may be further positioned at a distance, such as from about 0.5 mm to about 1 mm above the surface of the substrate or a surface of a previously deposited polymer layer. One of the two or more microplasma sources may be positioned higher above the surface of the substrate or the surface of the previously deposited polymer layer than another one of the two or more microplasma sources in relation to the surface of the substrate such that one of the at least two plasma drops precedes the path of polymer deposition. The microplasma source may be positioned separately from the extrusion nozzle.

According to some examples, a computer-readable storage medium with instructions stored thereon to increase interlayer adhesion of a 3D printed article may be described. The instructions may cause a method similar to the methods provided above to be performed when executed.

### EXAMPLES

Following are illustrative examples of how some embodiments may be implemented, and are not intended to limit the scope of embodiments in any way.

### Example 1

### An Extrusion Nozzle Coupled to a Dielectric Barrier Discharge (DBD) Microplasma Source Fabricated into a Silicon Chin

An extrusion nozzle may be coupled to a DBD device fabricated into a silicon chip. The DBD device may include a dielectric polyimide layer that separates the silicon chip from a sputtered Nickel layer. The polyimide layer and sputtered Nickel layer may further be encapsulated in a silicon nitride layer. The silicon chip may serve as a cathode and the sputtered Nickel layer may serve as the anode. The DBD device may be coupled to an extrusion nozzle such that a plasma drop from the DBD device precedes deposition of a polymer layer from the extrusion nozzle in a leading plasma configuration. As a result, the DBD device is positioned 0.5 mm above a surface of a substrate to prevent direct contact of the DBD device to the surface of the substrate.

Once positioned, the DBD device may be run in an alternating current (AC) mode with ±250 Volts (V) power at a frequency of 10 kiloHertz (kHz). The current may cause a plasma drop from the DBD device to the surface of the substrate to treat the surface of the substrate with DBD plasma. The plasma may be at a room temperature of approximately 290 K and may modify the surface of the substrate in less than 2 seconds. Hydroxyl radicals within the DBD plasma formed by activation of hydrogen gas in an ambient atmosphere of the DBD device may cause the surface of the substrate to oxidize, which may increase interlayer adhesion between the substrate and a next layer of polymer to be deposited by the extrusion nozzle.

### Example 2

### An Extrusion Nozzle Coupled to a DBD Microplasma Source Fabricated from Two or More Pieces of Aluminum

An extrusion nozzle may be coupled to a DBD device fabricated from two aluminum foils, each 70 micrometers thick, with one or more perforations extending through the thickness of the aluminum foils to allow an open configuration. The aluminum foils may be anodized to a depth of 10 micrometers to form aluminum oxide on one or more surfaces of the aluminum foils. The DBD device may be coupled to an extrusion nozzle such that a plasma drop from the DBD device follows deposition of a polymer layer from the extrusion nozzle in a trailing plasma configuration. As a result, the DBD device is positioned 1.0 mm above a surface of a deposited polymer layer to prevent direct contact of the DBD device to the surface of the deposited polymer layer.

Once positioned, the DBD device may be run in a 5-50 kV AC sweep at 275 V power to form the DBD plasma, and the open configuration may allow a mix of nitrogen and hydrogen gas passing through the perforations to activate in the DBD device 352 to form nitrogen oxide radicals within the DBD plasma. Upon application of the voltage, a plasma drop may treat the surface of the deposited polymer layer with the DBD plasma including the nitrogen oxide radicals. The nitrogen oxide radicals may cause oxidation of the treated surfaces, which may increase interlayer adhesion between the deposited polymer layer and a next layer of polymer to be deposited by the extrusion nozzle.

### Example 3

### An Extrusion Nozzle Integrated with Two Microhollow Plasma Sources

The extrusion nozzle may be coupled to two microhollow plasma sources that each include a dielectric layer of alumina formed in between two layers of molybdenum, where one layer of the molybdenum serves as a cathode and the other serves as an anode. The microhollow plasma sources may also include perforations formed with a laser, where the perforations may extend through the molybdenum and alumina layers to allow an open configuration and may be approximately 1000 micrometers in diameter. The open configuration may allow air to be passed and/or supplied continuously through the microhollow plasma source. Hydrogen, nitrogen, and oxygen gases within the air may be activated within the microhollow plasma sources to form hydroxyl radicals and nitrogen oxide radicals within the plasma.

The first microhollow plasma source may be coupled to the extrusion nozzle such that a plasma drop from the microhollow plasma precedes deposition of a polymer layer from the extrusion nozzle in a leading plasma configuration. As a result, the microhollow plasma is positioned about 0.5 mm above a surface of a substrate to prevent direct contact of the microhollow plasma to the surface of the substrate. Upon application of a 1-10 milliAmps (mA) current to the other molybdenum layer serving as the anode, a plasma drop may treat a surface of a substrate with the microhollow plasma, the plasma including the hydroxyl radicals and nitrogen oxide radicals. The microhollow plasma produced may include a high density and a high temperature, from 1000-2000 Kelvin (K), for example. The radicals may cause oxidation of the surface of the substrate, which may increase interlayer adhesion between the substrate and a polymer layer to be deposited by the extrusion nozzle.

The second microhollow plasma source may be coupled to the extrusion nozzle such that a plasma drop from the microhollow plasma follows deposition of a polymer layer from the extrusion nozzle in a trailing plasma configuration. As a result, the microhollow plasma may be positioned about 1.0 mm above a surface of a substrate to prevent direct contact of the microhollow plasma to a surface of a deposited polymer layer. Upon application of a 1-10 mA current to the other molybdenum layer serving as the anode, a plasma drop may treat the surface of the deposited polymer layer with the microhollow plasma including the hydroxyl radicals and nitrogen oxide radicals, where the radicals may cause oxidation of the surface of the deposited polymer layer. Oxidation of the surface may increase interlayer adhesion between the deposited polymer layer and a next polymer layer to be deposited by the extrusion nozzle.

There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various compositions, methods, systems, and devices are described in terms of “comprising” various components or steps (interpreted as meaning “including, but not limited to”), the compositions, methods, systems, and devices can also “consist essentially of” or “consist of” the various components and steps, and such terminology should be interpreted as defining essentially closed-member groups.”

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof, and that designing the circuitry and/or writing the code for the software and or firmware would be possible in light of this disclosure.

The present disclosure is not to be limited in terms of the particular embodiments described in this application, which are intended as illustrations of various aspects. Many modifications and variations can be made without departing from its spirit and scope Functionally equivalent methods and apparatuses within the scope of the disclosure, in addition to those enumerated herein, will be possible from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, systems, or components, which can, of course, vary. It is also to be understood that the terminology used herein is for the purpose of describing particular embodiments only, and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that particular functionality is achieved. Hence, any two components herein combined to achieve a particular functionality may be seen as “associated with” each other such that the particular functionality is achieved, irrespective of architectures or intermediate components. Likewise, any two components so associated may also be viewed as being “operably connected”, or “operably coupled”, to each other to achieve the particular functionality, and any two components capable of being so associated may also be viewed as being “operably couplable”, to each other to achieve the particular functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method to increase interlayer adhesion of a three-dimensional (3D) printed article, the method comprising:
positioning an extrusion nozzle of a 3D printer along a path;
coupling a microplasma source to the extrusion nozzle such that the microplasma source is positioned along the path of the extrusion nozzle, wherein the microplasma source is positioned to either precede or follow the extrusion nozzle along the path;
depositing a polymer layer from the extrusion nozzle along the path onto a surface of a substrate to form the 3D printed article; and
treating the surface of the substrate or a surface of the deposited polymer layer with plasma from the microplasma source by applying a voltage between a ground reference and at least one of two electrodes positioned within the microplasma source to cause a plasma drop from the microplasma source onto the surface of the substrate or the surface of the deposited polymer layer.

2. The method of claim 1, further comprising:
supplying one or more gases to the microplasma source, wherein the one or more gases are activated to form at least one reactive species in the plasma that oxidizes the surface of the substrate or the surface of the deposited polymer layer to increase an interlayer adhesion.

3.-4. (canceled)

5. The method of claim 1, wherein treating the surface of the substrate or the surface of the deposited polymer layer with plasma from the microplasma source comprises:
applying the voltage between the ground reference and the at least one of two electrodes positioned within the microplasma source to cause the plasma drop from the microplasma source onto a surface of a previously deposited polymer layer prior to a deposition of another polymer layer.

6. The method of claim 1, further comprising:
positioning the microplasma source from about 0.5 mm to about 1 mm above the surface of the substrate or the surface of the deposited polymer layer.

7. The method of claim 1, further comprising:
rotating the extrusion nozzle as the polymer layer is deposited to track changes in a polymer deposition.

8. The method of claim 1, further comprising:
incorporating the microplasma source into the extrusion nozzle to allow treatment of the polymer layer with the plasma as the polymer layer is deposited from the extrusion nozzle.

9. A printhead, comprising:
an extrusion nozzle of a three-dimensional (3D) printer configured to deposit one or more polymer layers onto a surface of a substrate to form a 3D printed article; and
a microplasma source incorporated into the extrusion nozzle, the microplasma source configured to treat a surface of the substrate or a surface of a deposited polymer layer with plasma from the microplasma source as the one or more polymer layers are deposited from the extrusion nozzle.

10. The printhead of claim 9, further comprising two or more electrodes positioned within the microplasma source, wherein the microplasma source is configured to apply a voltage between a ground reference and at least one of the two or more electrodes to cause a plasma drop to be deposited from the microplasma source onto the surface of the substrate or the surface of each polymer layer.

11.-14. (canceled)

15. The printhead of claim 9, wherein the microplasma source is a macro-scale dielectric barrier discharge (DBD) source, a microhollow plasma source, or a radio frequency (RF) plasma source.

16. (canceled)

17. The printhead of claim 15, wherein the microplasma source is composed of one or more silicon chips or two or more mated pieces of perforated aluminum.

18. The printhead of claim 9, wherein the microplasma source is configured to deposit plasma to the surface of the substrate or the surface of the deposited polymer layer with plasma that comprises at least one reactive species.

19. The printhead of claim 18, further comprising:
a gas source coupled to the microplasma source, wherein the microplasma source is further configured to pass through one or more gases received from the gas source in an open configuration to allow activation of the one or more gases to form the at least one reactive species.

20. The printhead of claim 18, further comprising:
a gas source coupled to the microplasma source, wherein the microplasma source is further configured to ionize one or more gases received from the gas source in a closed configuration to allow activation of the one or more gases to form the at least one reactive species.

21. The printhead of claim 18, wherein the at least one reactive species include a hydroxyl radical or nitrogen oxide radical.

22. A system to increase interlayer adhesion of a three-dimensional (3D) printed article, the system comprising:
a deposition module comprising an extrusion nozzle of a 3D printer positioned along a path, the deposition module configured to deposit one or more polymer layers from the extrusion nozzle along the path onto a surface of a substrate to form a 3D printed article;
a treatment module comprising two or more microplasma sources coupled to the extrusion nozzle and positioned along the path of the extrusion nozzle such that a first of the two or more microplasma sources precedes the extrusion nozzle and a second of the two or more microplasma sources follows the extrusion nozzle, the treatment module configured to treat a surface of the substrate or a surface of the one or more deposited polymer layers with plasma from the two or more microplasma sources; and
a controller configured to coordinate operations of the deposition module and the treatment module during a fabrication of the 3D printed article.

23. The system of claim 22, wherein the treatment module further comprises two or more electrodes positioned within each of the two or more microplasma sources, wherein each of the two or more microplasma sources is configured to apply a voltage between a ground reference and at least one of the two or more electrodes to cause a plasma drop to be deposited from each of the two or more microplasma sources onto the surface of the substrate or the surface of the one or more deposited polymer layers.

24. (canceled)

25. The system of claim 23, wherein plasma drop deposited from the first of the two or more microplasma sources precedes a path of polymer deposition from the extrusion nozzle and a plasma drop deposited from the second of the two or more microplasma sources follows a path of polymer deposition from the extrusion nozzle.

26. The system of claim 22, wherein the two or more microplasma sources are further positioned from about 0.5 mm to about 1 mm above the surface of the substrate or a surface of a previously deposited polymer layer.

27. The system of claim 26, wherein the first of the two or more microplasma sources that precedes the extrusion nozzle is positioned higher above the surface of the substrate or the surface of the previously deposited polymer layer relative to the second of the two or more microplasma sources follows the extrusion nozzle.

28. The system of claim 22, wherein the two or more microplasma source are positioned separately from the extrusion nozzle.

29. (canceled)
